(19) United States
(12) Patent Application Publication
(10) Pub. No.: US 2009/0225963 A1
(43) Pub. Date: Sep. 10, 2009

(54) MUSICAL CALLER ID APPARATUS AND METHOD

(75) Inventors: CHUAN-HONG WANG, Tu-Cheng (TW); Li-Zhang Huang, Tu-Cheng (TW); Hsiao-Chung Chou, Tu-Cheng (TW); Xiao-Guang Li, Shenzhen City (CN); Kuan-Hong Hsieh, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/212,657

(22) Filed: Sep. 18, 2008

(30) Foreign Application Priority Data
Mar. 7, 2008 (CN) 200810065790.6

(51) Int. Cl. H04M 1/64

(52) U.S. Cl. 379/88.19

(57) ABSTRACT

A computer-implemented method for identifying a user corresponding to an incoming call is provided. The method includes receiving an incoming call and decoding a phone number of the incoming call. The method further includes assigning one or more musical notes associated with one or more numbers in the phone number according to a musical note table and composing the corresponding musical notes of with the corresponding a predetermined music selection of a determined class to generate a ring music. The method further includes obtaining corresponding audio clip of each musical note of the ring music from the audio clip database and outputting the audio clips through a music output device.

### BACKGROUND

1. Field of the Disclosure

Embodiments of the present disclosure relate to caller identification (ID), and more particularly to apparatus and method for generating a music caller ID.

2. Description of the Related Art

Portable communication apparatus, such as cell phones, have become indispensable tools in our daily lives. Many functions are available now with our cell phones, for example, caller ID, among other things. Caller ID allows users to easily screen their calls.

Recently, a caller ID system has been developed that can audibly reveal a phone number and/or other information of a received call by the use of an electronically generated voice so that a user does not even have to look at his/her phone to know who is calling.

One such caller ID system obtains voice clips corresponding to one or more numbers (0-9) of a phone number of an incoming call, from an audio clip database, and sends the proper combination and sequence of voice clips to a voice generating chip to be output to a user.

However, even the caller ID system is convenient, the sound of the voice clips may not be pleasing to the human ears.

Therefore, what is needed is an improved caller ID apparatus for identifying callers.

### SUMMARY

A computer-implemented method for identifying a user corresponding to an incoming call is provided. The method includes: providing a data storage for storing a musical note table, a music parameters table, an audio clip database, the musical note table assigning a musical note for each digit (0-9), the music table recording relationships between phone number classes and a predetermined music selection, and the audio clip database storing pre-recorded audio clips of which is played in different parameters; receiving an incoming call and decoding the phone number of the incoming call and storing the phone number in the data storage; recognizing a respective phone number class according to the phone number; determining a corresponding predetermined music selection of the recognized phone number class of the phone number in the music table; obtaining a digit set from the phone number stored in the data storage; assigning the musical notes associated with the numbers of the digit set according to the musical note table; composing the corresponding musical notes of the digit set with the corresponding predetermined music selection of the determined class to generate a ring music; obtaining a corresponding audio clip for each musical note of the ring music from the audio clip database and outputting the audio clip(s) through a music output device

### BRIEF DESCRIPTION OF THE DRAWINGS

The components of the drawings are not necessarily drawn to scale, the emphasis instead being placed upon clearly illustrating the principles of the musical caller ID apparatus. Moreover, in the drawings, like reference numerals designate corresponding parts throughout several views.

FIG. 1 is a block diagram of an musical caller ID apparatus in accordance with one embodiment of the present disclosure.

FIG. 2 is a flowchart of one embodiment of a method for outputting audio signal corresponding to receiving an incoming call.

### DETAILED DESCRIPTION

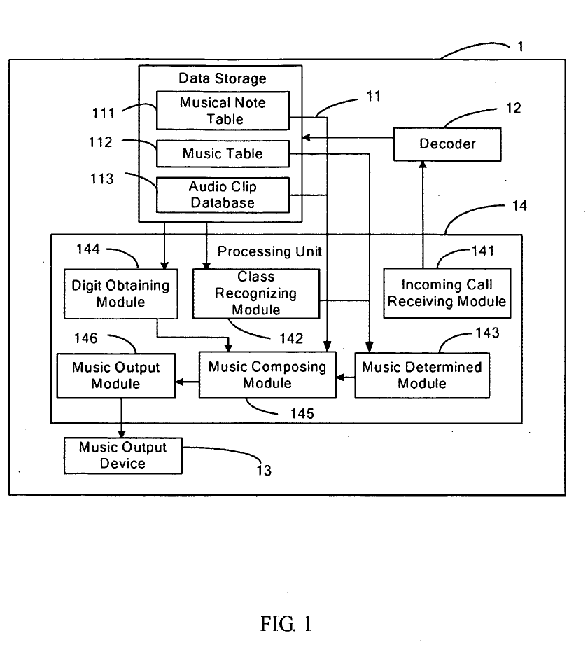

FIG. 1 is a block diagram of a musical caller ID apparatus 1 (hereinafter “the apparatus”) in accordance with one embodiment of the present disclosure. In one embodiment, the apparatus 1 includes a data storage 11, a decoder 12, a music output device 13, and a processing unit 14. The data storage 11 stores a musical note table 111, a music table 112, and an audio clip database 113 as will be further described herein. In one embodiment, the apparatus 1 may be a cellphone, personal digital assistance (PDA), or other apparatus with a communication and audio function.

The musical note table 111 assigns a musical note for each digit (0-9) in a received phone number (hereinafter, “the call number”), as shown in the following Table 1.

TABLE 1

| | Digit | | | | | | | | | |
|---|---|---|---|---|---|---|---|---|---|---|
| | 1 | 2 | 3 | 4 | 5 | 6 | 7 | 8 | 9 | 0 |
| Note | do | re | mi | fa | sol | la | ti | do | re | mi |

The relationship between the digits and the musical notes is not limited to that defined in the musical note table 111. The relationship can also be defined by the user. The musical note table 111 is based on the “Just Intonation Music Scale” as an example, but other scales can be used according to manufacturer or user preference.

The music table 112 records a relationship between phone number classes and a predetermined music selection. The phone number can be classified according to a plurality of classes. One way to classify the phone number is classify the phone number according to family members, friends, colleagues, classmates, and relatives according to a relationship between the caller and the user. Another way to classify the phone number is classify the phone number according to an unable-recognized call, an international call, a national call, and a local call according to the incoming phone number. The way of classifying the phone numbers is not limited to the above two ways, and other classified ways also are permitted. The music table 112 includes a class row and a music row. The class row records different classes of the phone numbers. The music row records a corresponding music of each phone number class. In this embodiment, the phone number classes “unable-recognized, international call, national call, and local call” are taken for example.

TABLE 2

| | | | | |
|---|---|---|---|---|
| Class | Unable-recognized | International Call | National Call | Local |
| | | | | Call |
| Music | Music 1 | Music 2 | Music 3 | Music 4 |

The audio clip database 113 stores prerecorded audio clips of each musical note. Taking musical note “do” for example, the audio clips of the musical note “do” that is played is stored in the audio clip database. These musical notes may be predetermined as mentioned above.

The processing unit 14 includes an incoming call receiving module 141, a class recognizing module 142, a music determining module 143, a digit obtaining module 144, a music composing module 145, and a music output module 146. The modules 141, 142, 143, 144, 145, 146 may be used to execute one or more operations for the apparatus 1 as will be further described below.

The incoming call receiving module 141 is configured for receiving an incoming call and sending the incoming call to a decoder 12 to obtain a phone number of the incoming call and storing the phone number in the data storage 11.

The class recognizing module 142 is configured for recognizing which class the phone number belongs to. The music determining module 143 is for determining corresponding music of the determined class of the phone number in the music table 112.

The digit obtaining module 142 is configured for selecting one or more digits of the phone number (hereinafter, “the digit set”) stored in the data storage 11. It may be understood that the digit set may comprise all the digits of the phone number, or may comprise some of the digits of the phone number. For example, if the phone number is “13956123846,” a user, not wanting a long musical note melody, may associate an abbreviated digit pattern with the phone number. The digit pattern may, for example, use only the third, sixth, eighth, tenth, and eleventh digits of the phone number, so the digit set is “91346.” Selective selection of digits of the phone number may be useful for a user to remember who is calling based on the sound of outputted sound.

The music composing module 145 is configured for receiving a digit set from the digit obtaining module 142, assigning the musical notes associated with the numbers of the digit set according to the musical note table 111, and composing the corresponding musical notes of the digit set with the corresponding music of the determined class to generate a ring music. In this embodiment, during the composing process, the corresponding music of the determined class is placed before the corresponding musical notes of the digit set. In other embodiments, other composing ways are also permitted.

The music outputting module 146 is configured for obtaining corresponding audio clip of each musical note of the ring music from the audio clip database 113 and outputting the audio clips through the music output device 13.

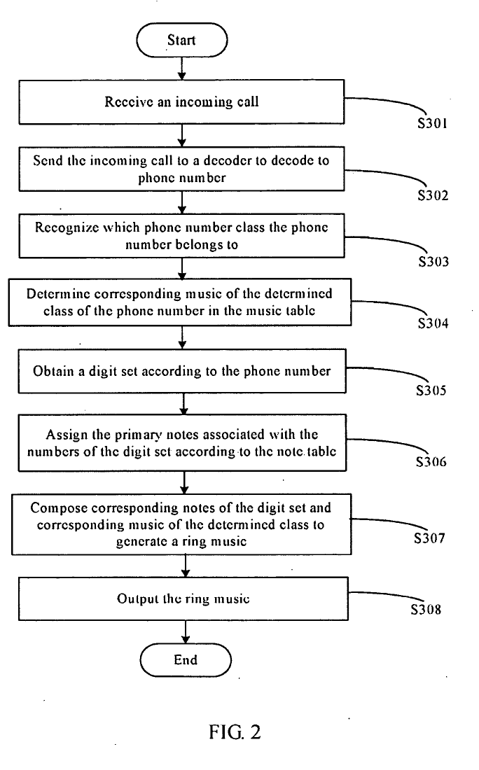

FIG. 2 is a flowchart of one embodiment of a method for outputting audio signal corresponding to receiving an incoming call. Depending on the embodiment, additional blocks may be added, others deleted, and the ordering of the blocks may be changed. In block S301, the incoming call receiving module 141 receives the incoming call.

In block S302, the incoming call receiving module 141 sends the incoming call to a decoder 12 to decode to a phone number of the incoming call and to store the phone number in the data storage 11.

In block S303, the class recognizing module 142 recognizes which phone number class the phone number belongs to.

In block S304, the music determining module 143 determines corresponding music of the determined class of the phone number in the music table 112.

In block S305, the digit obtaining module 142 obtains a digit set according to the phone number stored in the data storage 11.

In block S306, the music composing module 145 receives the digit set from the digit obtaining module 142, and assigns the musical notes associated with the numbers of the digit set according to the musical note table 111.

In block S307, the music composing module 145 composes the corresponding musical notes of the digit set and the corresponding music of the determined class to generate a ring music.

In block S308, the music outputting module 146 obtains corresponding audio clip of each musical note of the ring music from the audio clip database 113 and outputs the audio clips through the music output device 13. Although the present disclosure has been specifically described on the basis of various inventive embodiment, the present disclosure is not to be construed as being limited thereto. Various changes or modifications may be made to the embodiments without departing from the scope and spirit of the present disclosure.

What is claimed is:

1. A musical caller identification (ID) apparatus, comprising:
a data storage that stores a musical note table, a music table, and an audio clip database, the musical note table assigning a musical note for each digit (0-9) in a received phone number of an incoming call, the music table recording relationships between phone number classes and predetermined music selections, and the audio clip database storing prerecorded audio clips of each musical note;
a decoder configured for decoding the phone number;
an incoming call receiving module configured for receiving the incoming call and sending the incoming call to the decoder to decode the phone number of the incoming call and storing the phone number in the data storage;
a class recognizing module configured for recognizing a corresponding phone number class for the phone number;
a music determining module configured for determining a corresponding music selection of the recognized phone number class;
a digit obtaining module configured for obtaining a digit set from the phone number stored in the data storage;
a music composing module configured for receiving the digit set from the digit obtaining module; assigning the musical notes associated with the numbers of the digit set according to the musical note table; and composing the corresponding musical notes of the digit set with the corresponding predetermined music selection of the determined class to generate a ring music;
a music outputting module configured for obtaining a corresponding audio clip for each musical note of the ring music from the audio clip database and outputting the audio clips through a music output device.

2. The apparatus as described in claim 1, wherein the digit set consists of all digits of the phone number.

3. The apparatus as described in claim 1, wherein the digit set consists of a subset of digits of the phone number.

4. The apparatus as described in claim 1, wherein the phone number classes are classified according to family members, friends, colleagues, classmates, and relatives according to a relationship between the caller and the user.

5. The apparatus as described in claim 1, wherein phone number classes are classified according to an unable-recognized call, an international call, a national call, and a local call according to the phone number.

6. A computer-implemented method for identifying a user corresponding to an incoming call, comprising:
providing a data storage for storing a musical note table, a music parameters table, an audio clip database, the musical note table assigning a musical note for each digit (0-9), the music table recording relationships between phone number classes and a predetermined music selection, and the audio clip database storing prerecorded audio clips of each musical note;
receiving an incoming call and decoding the phone number of the incoming call and storing the phone number in the data storage;
recognizing a respective phone number class according to the phone number;
determining a corresponding music selection of the recognized phone number class;
obtaining a digit set from the phone number stored in the data storage;
assigning the musical notes associated with the numbers of the digit set according to the musical note table;
composing the corresponding musical notes of the digit set with the corresponding predetermined music selection of the determined class to generate a ring music;
obtaining a corresponding audio clip for each musical note of the ring music from the audio clip database and outputting the audio clip(s) through a music output device.
